(19) United States
(12) Patent Application Publication
(10) Pub. No.: US 2012/0252296 A1
(43) Pub. Date: Oct. 4, 2012

(54) WATER=pERMEABILITY STRETCH KNITTED FABRIC

(75) Inventors: Masanobu Sato, Otsu-shi (JP); Ujiteru Niwa, Kusatsu-shi (JP); Hirokazu Ide, Iyo-gun (JP)

(73) Assignee: TORAY INDUSTRIES, INC., Tokyo (JP)

(21) Appl. No.: 13/438,353

(22) Filed: Apr. 3, 2012

Related U.S. Application Data
(63) Continuation of application No. 12/376,325, filed on Feb. 4, 2009, now abandoned.

(51) Int. Cl. B32B 5/26; D04B 1/16

(52) U.S. Cl. 442/309; 442/310

(57) ABSTRACT

The water-permeability stretch knitted fabric has a multi-layered structure including at least two layers, namely the outer layer and the inner layer, wherein 30% or more of the outer layer of the knitted fabric is accounted for by composite fiber multifilament yarns composed of two types of polyester polymer materials adhered to each other side by side in the fiber's length direction, the water-permeability of the knitted fabric being such that both the water absorption back-and-front moisture content ratio and the water absorption back-and-front diffusion area ratio between the outer layer and the inner layer are two or more, and the average for the stretch percentages and that for the stretch recovery percentages in the longitudinal and transverse directions of the knitted fabric being 55% or more and 60% or more, respectively.

### RELATED APPLICATIONS

This is a continuation of U.S. Ser. No. 12/376,325, fled Feb. 4, 2009, which is a §371 of International Application No. PCT/JP2006/315701, with an international filing date of Aug. 9, 2006 (WO 2008/018122 A1, published Feb. 14, 2008).

### TECHNICAL FIELD

This disclosure relates to a water-permeability stretch knitted fabric for clothing and other materials that is high in sweat removing performance and also high in stretchability and stretch recovery which are essential properties for comfortable clothing.

### BACKGROUND

Knitted fabrics can be higher in stretchability than woven fabrics due to their fabric structure, enabling easy movement of the wearer. Accordingly, knitted fabrics have been conventionally used in many fields for general clothing such as innerwear, outerwear, and sportswear; hosiery such as pantyhose; clothing materials such as lining, interfacing; and industrial materials such as chair upholstery.

In recent years, however, there have been greater demands for knitted fabrics, particularly for innerwear, sportswear, and lining, that fit the body of the wearer comfortably to enable easy movement and show high sweat removing performance during perspiration. To meet them, various technical improvements have been proposed to provide better fibers and knit structures for knitted fabrics.

In particular, many studies have been carried out about a new type of stretch knitted fabrics called spandex that combine nylon fiber, polyester fiber, or cotton yarns with specific polyurethane-based elastic fibers to achieve high stretchability and stretch recovery.

Though such polyurethane-based elastic fibers have high stretchability, however, combining them with other fibers will lead to stiff texture because of inherent properties of polyurethane, leading to deterioration in texture and drape property of the knitted fabrics. When combined with polyester fibers, furthermore, they cannot be dyed easily with disperse dyes designed for polyester, and this will cause persistent problems such as pollution of washing wastewater and decrease in the wet rubbing fastness of the knitted fabrics, leading to difficulty in achieving intended colors by dying as well as requiring a complicated dyeing process comprising strong reduction cleaning. In addition, a decreased heat resistance can cause problems such as roughening of the outer of the knitted fabrics. Polyurethane-based elastic fibers, furthermore, require very large costs (see JP-B-H01-040137).

Some methods have been adopted, for instance, to develop stretchability by combining polyester fibers or nylon fibers that are false-twisted so that a torque is produced by twisting and untwisting or by combining polybutylene terephthalate fibers, although still failing to provide knitted fabrics with a sufficiently satisfactory stretchability (see JP-A-H06-101116).

It could therefore be helpful to provide water-permeability stretch knitted fabrics that have high stretchability and stretch recovery, as well as water-permeability.

### SUMMARY

We provide water-permeability stretch knitted fabrics that include a knitted fabric of a multi-layered structure, comprising at least two layers, namely the outer layer and the inner layer, wherein 30% or more of the outer layer is accounted for by multifilament yarns (a) that comprise composite fiber filaments composed of two types of polyester polymer materials adhered to each other side by side in the fiber's length direction, the water-permeability of the knitted fabric being such that both the water absorption back-and-front moisture content ratio and the water absorption back-and-front diffusion area ratio between the outer layer and the inner layer are two or more, and the average for the stretch percentages and that for the stretch recovery percentages in the longitudinal and transverse directions of the knitted fabric being 55% or more and 60% or more, respectively.

These fabrics serve to simultaneously maintain water-permeability, stretchability, and stretch recovery, which cannot be achieved in the conventional knitted fabrics. Thus, we provide thin to medium-thick water-permeability stretch knitted fabrics with sufficiently high sweat removing performance and stretchability to be produced efficiently and economically, serving to provide useful materials for sportswear, innerwear, lining, and other articles used in various fields.

### BRIEF DESCRIPTION OF THE DRAWINGS

FIG. 1 illustrates typical load vs. stretch recovery curves for the multi-layered structure knitted fabric.

FIG. 2 schematically shows a cross section of the side-by-side type composite fiber filaments that constitute the multifilament yarns (a).

FIG. 3 illustrates the knitting diagrams used to produce knitting fabrics in Examples 1 to 3 and Comparative Examples 1 and 3.

FIG. 4 illustrates the knitting diagram used to produce knitting fabrics in Comparative Example 2.

### EXPLANATION OF SYMBOLS

L1: elongation of knitted fabric
L2: strain elongation of knitted fabric
L3: recoverable elongation of knitted fabric
(1) to (3): cross section of fiber
α: circumscribed circle of cross section of fiber
β: inscribed circle of cross section of fiber
A: straight line connecting two concave portions
B: longest portion of the straight line at right angles to the line A
F1 to F8: numbers of yarn feeding ports of the knitting machine
D1 to D5: knitting needle on the dial side
C1 to C6: knitting needle on the cylinder side
E1: yarn on the inner layer side of the knitted fabric
E2: yarn on the outer layer side of the knitted fabric

### DETAILED DESCRIPTION

After studying the aforementioned issues in producing water-permeability stretch knitted fabrics that have high stretchability, stretch recovery, and water-permeability while maintaining required mechanical strength, chemical resistance, dyeing processability, softness, and fluffiness, we found that the problem would be solved completely when they produced the multi-layered structure knitted fabric using a specific type of multifilament yarns to constitute the outer layer of the multi-layered structure knitted fabric.

In general, clothing such as innerwear, sportswear, and lining is worn in contact with the skin and, therefore, they are required to maintain high sweat absorption performance continuously for a long period of time to control heavy perspiration from the skin during exercise and labor in summer and also have high drying ability to allow sweat to transpire rapidly into the air and high washability to resist frequent washing.

It is generally known that high-count multifilaments, modified cross-section multifilaments and spun yarns with a low monofilament fineness tend to contain many small interfiber gaps to cause high water-permeability due to the capillary mechanism and, therefore, they are suited to produce water-permeability knitted fabrics. Thus, if such high-count multifilaments, modified cross-section multifilaments or spun yarns with a low monofilament fineness are used to constitute the outer layer of multi-layered structure knitted fabrics, sweat absorbed through the inner layer of the multi-layered structure knitted fabrics will be rapidly transported to the outer layer, serving to prevent stickiness and chilly feeling during perspiration and achieve quick-drying performance.

These techniques are combined with others to provide clothing such as innerwear, sportswear, and lining that can maintain high sweat absorption performance continuously for a long period of time to control heavy perspiration from the skin during exercise and labor in summer and that, in addition to this, specific multifilament yarns are used along with a specific multi-layered structure to provide water-permeability stretch knitted fabrics that have satisfactorily high stretchability.

The water-permeability stretch knitted fabrics contain multifilament yarns (a) that comprise composite fiber filaments composed of polyester polymer materials of different types adhered to each other side by side in the fiber's length direction and having at least one concave portion. Side-by-side type composite fiber filaments that constitute the multifilament yarns (a) are composed of polymer materials that differ in polymer species, intrinsic viscosity, copolymerization composition, or copolymerization degree adhered to each other to develop crimps as a result of differences in elastic recovery percentage or shrinkage characteristics. Thus, we make clever use of these characteristics. Specifically, the side-by-side type composite fiber filaments composed of polymers with different viscoelasticities will suffer a concentrated stress in the high-viscosity component during spinning or stretching, leading to different internal strains between the two components. The difference caused in the elastic recovery percentage after the stretching and that caused in the heat shrinkage degree during the heat treatment step of the knitted fabrics leads to shrinkage in the high-viscosity component, and as a result, a strain will develop in the monofilaments to produce three-dimensional coil crimps. It can be said that the diameter of these three-dimensional coils and the number of coils per unit fiber length depend on the difference in the degree of shrinkage (including the difference in elastic recovery percentage) between the high-shrinkage component and the low-shrinkage component, indicating that the diameter of these three-dimensional coils decreases and the number of coils per unit fiber length increases with the difference in the degree of shrinkage.

Coil crimps in stretch material are required to be small in coil diameter, large in the number of coils per unit fiber length (for good elongation characteristics and good appearance), high in resistance to coil flattening (small coil flattening relative to stretch recovery, and high stretch retention performance), and small in hysteresis loss during coil's stretch recovery (highly springy, fitting comfortably). The coil diameter should preferably be 250 μm or less, more preferably 200 μm or less.

With respect to the phase of coils produced in the length direction of the multifilament yarns, each multifilament yarn will work like a spring when all filaments constituting the yarn are in the same coil phase. A knitted fabric produced from such yarns will be fluffy and soft, and have a beautiful surface with fine crimps. When the filaments constituting the yarn are not in the same coil phase, on the other hand, the filaments in each multifilament yarn will be bulging randomly, and appear to be false-twisted multifilament yarns that could result after false-twisting and untwisting. A knitted fabric produced from these yarns will be fluffy and soft, and have a beautiful flat surface. Furthermore, the random arrangement of the filaments will serve to produce many small gaps between single yarns, and this leads to an increase in the water-permeability of the fiber, hence that of the knitted fabric, resulting in a good water-permeability stretch knitted fabric.

Multifilament yarns (a) in which the side-by-side type composite fiber filaments are in the same coil phase should be used when the knitted fabric needs to have crimps on its surface, while multifilament yarns (a) in which the side-by-side type composite fiber filaments are not in the same coil phase should be used when it needs to have a flat surface.

To produce multifilament yarns (a) in which the side-by-side type composite fiber filaments are in the same coil phase, the side-by-side type composite fiber filaments should be lower in the degree of modification. Low-modification filaments can move easily in the fibers, allowing the filaments to come in the same coil phase. For our fabrics, however, it is important to improve the water-permeability, and the multifilaments used need to have at least one concave portion and at the same time have a modification degree of 1.3 or more. Multifilament yarns (a) of filaments in the same coil phase will be produced easily by winding the multifilament yarns continuously while maintaining them under tension during the stretching and winding steps.

To produce multifilament yarns (a) in which the side-by-side type composite fiber filaments are not in the same coil phase, on the other hand, the side-by-side type composite fiber filaments should be higher in the degree of modification. High-modification filaments cannot move easily in the fibers, and the shifts in phase, once caused, will not disappear during the yarn production step, leading to multifilament yarns in which the filaments are not in the same coil phase. As the degree of modification increases, however, the fibers will become more likely to fracture and start to suffer fibrillation, leading to deterioration in processability and quality. Thus, the degree of modification must be 6.0 or less. Multifilament yarns (a) of filaments in the same coil phase will be produced easily by providing a relaxation step between the stretching and winding steps to relax the multifilament yarn before winding it continuously.

A water-permeability stretch knitted fabric having a good overall balance can be produced by maintaining good inherent characteristics of polyester, such as moderate bending strength, drape, and high dye fastness, while meeting the aforementioned requirements. Here, the characteristics of the high-shrinkage component (high-viscosity component) are the key to meeting the requirements for the coil characteristics. The stretching properties of the coils depend mainly on those of the high-shrinkage component working on the low-shrinkage component as fulcrum, and accordingly, the polymer material used as the high-shrinkage component should have high stretchability and stretch recovery.

Thus, we carried out studies to achieve the characteristics while meeting the good characteristics of polyester, and found that it was preferable to use a polyester material composed mainly of polytrimethylene terephthalate (hereinafter referred to as PTT) for the high-shrinkage component. The PTT fiber has a very high stretch recovery performance while having as good dynamic and chemical characteristics as those of such representative polyester fibers as polyethylene terephthalate (hereinafter referred to as PET) fiber and polybutylene terephthalate (hereinafter referred to as PBT) fiber. It is considered that this is attributed to the fact that the methylene chain in the alkylene glycol portion of the PTT crystal structure forms a gauche-gauche structure (in which the molecule chains are bent at 90 degrees) and that the density of the constraint points due to the interaction (stacking, parallel) among benzene rings is low while the flexibility is high, allowing the methylene groups to rotate smoothly to achieve easy stretching and recovery of the molecular chains.

Here, PTT is a polyester consisting of terephthalic acid as the major acid component and 1,3-propanediol as the major glycol component. The material to be used, however, may contain 20 mol %, more preferably 10 mol % or less, of a copolymerization component that can form an ester bond of another type. The compounds that can be used for copolymerization include, but not limited to, dicarboxylic acids such as isophthalic acid, succinic acid, cyclohexanedicarboxylic acid, adipic acid, dimeric acid, sebacic acid, and 5-sodium sulfoisophthalic acid; and diols such as ethylene glycol, diethylene glycol, butanediol, neopentyl glycol, cyclohexanedimethanol, polyethylene glycol, and polypropylene glycol. In addition, the material may contain, as needed, titanium dioxide as delustering agent, fine particles of silica and alumina as lubricant, hindered phenol derivative as antioxidant, and other additives such as color pigment.

There are no specific limitations on the polyester material for the low-shrinkage component if it is a fiber-forming polyester that has stable yarn-forming capability as well as high interface adhesiveness with the high-shrinkage component. Fiber-forming PTT, PET, and PBT polymers are preferred as material for the low-shrinkage component in consideration of their dynamic characteristics, chemical characteristics, and raw material prices.

The melt viscosity of the PTT material at the spinning temperature should preferably be 1.0 to 5.0 times that of the other, i.e., low-shrinkage, component at the spinning temperature. If the ratio is adjusted to 1.0 or more, preferably 1.1 or more, the PTT material will receive a larger spinning stress during the fiber formation step in the spinning process, leading to a higher crimp forming capability. Adjusting the ratio to 5.0 or less, preferably 4.0 or less, on the other hand, will facilitate the control of the composite morphology, and make it possible to maintain the bending of the polymer discharged from the orifice at a sufficiently low level.

The optimum composition ratio of the two components depends on their yarn-forming capability and the uniformess of the coil size in the fiber's length direction, and specifically the ratio between the high-shrinkage component and the low-shrinkage component should preferably be 75:25 to 35:65 (in terms of weight percentage), more preferably 65:35 to 45:55.

There are no specific limitations on the cross-sectional shape of the side-by-side type composite fiber filaments that constitute the multifilament yarns (a), but their cross section should preferably have at least one concave portion with a modification degree in the range of 1.3 to 6.0. Such cross-sectional shapes include multilobar, C-shape, M-shape, H-shape, X-shape, W-shape, I-shape, and + shape. Multifilament yarns (a) comprising side-by-side type composite fiber filaments with a cross section of snowman-like shape as shown in FIG. 2a are preferred in terms of the balance among the crimp-forming performance, water-permeability, and texture.

The snowman-like shape for the cross section of the fiber consists of two adjacent circles or ellipses connected to each other as shown in FIG. 2a, and the two circular portions should preferably comprise polymers of different compositions. There are no specific limitations on the snowman-like cross section of the fiber if its modification degree is in the range of 1.3 to 6.0, but the ratio (B/A) between the length of the straight line connecting the two concave points, A, and that of the longest portion of the straight line at right angles to the former, B, should preferably be in the range of 1.0 to 5.0. The ratio B/A should more preferably be in the range of 2.0 to 4.0 considering the yarn-forming performance and the physical properties of the resulting knitted fabric.

The side-by-side type composite fiber filaments should preferably have a monofilament fineness in the range of 0.1 to 11 decitex. Side-by-side type composite fiber filaments with a monofilament fineness of 11 decitex or less will serve to produce knitted fabrics with a soft texture that can be used preferably as material for clothing. Moreover, it should more preferably be 5.5 decitex or less for fabrics that will be used in direct contact with the skin. Good composite yarns can be produced and high stretchability attributable to the crimp structure can be achieved if the fineness is 0.1 decitex or more, more preferably 1.1 decitex or more. Furthermore, combined filament yarns comprising monofilaments different in fineness may also be used. The use of combined filament yarns comprising monofilaments different in fineness is preferred because it can serve to produce soft and firm knitted fabrics.

The multifilament yarns (a) should preferably be filaments yarns with a total fineness of 22 to 330 decitex. Furthermore, the total fineness should more preferably be in the range of 33 to 110 decitex if the yarns are to be used for production of thin fabric, or 55 to 220 decitex for thick fabrics.

A knitted fabric of a specific multi-layered structure with high water-permeability and stretchability is produced by using the aforementioned multifilament yarns (a) so that they account for 30% or more of the outer layer of the knitted fabric.

Specifically, the water-permeability stretch knitted fabric is characterized in that it has high water-permeability such that the ratio of the water absorption back-and-front moisture content of the outer layer to that of the inner layer of the knitted fabric is two or more and the water absorption back-and-front diffusion area ratio between them is also two or more. The water absorption back-and-front moisture content ratio and water absorption back-and-front diffusion area ratio should preferably be three or more, more preferably four or more. The fabric would feel sticky on the sweaty skin if these ratios are less than two.

Adjusting these ratios to two or more will allow the knitted fabric to have a high water-permeability and permeability to facilitate sweat secreted during exercise or labor to be absorbed through the knitted fabric's inner layer that is in contact with the skin and transported into the outer layer and at the same time show high performance in diffusing, transpiring, and drying the sweat in the knitted fabric's outer layer, serving to reduce the stickiness during heavy perspiration and achieving high comfortability.

To achieve a high water-permeability such that both the water absorption back-and-front moisture content ratio and the water absorption back-and-front diffusion area ratio are two or more, it is important for the side-by-side type composite fiber filaments constituting the multifilament yarns (a) to have such a modified cross-section shape as described above and for the multifilament yarns (a) to account for 30 wt % or more of the outer layer of the multi-layered structure knitted fabric. In general, conventional water-permeability stretch knitted fabrics have been produced by using yarns having a modified cross section with portions concave in the fiber's length direction or yarns with a low filament fineness to improve the water-permeability while using spandex or highly crimped yarns to improve the stretchability. As described above, however, the use of spandex would cause problems such as stiffening of texture, decrease in fastness, need of more cumbersome processing, and increase in cost, while satisfactory stretchability cannot be achieved with highly crimped yarns. With this disclosure, a high water-permeability and stretchability are achieved simultaneously by using the multifilament yarns (a) comprising side-by-side type composite fiber filaments with a specific modified cross section, enabling knitted fabrics to be produced more easily and efficiently. If the multifilament yarns (a) account for 30 wt % or more of the outer layer, it will be possible for the sweat absorbed through the inner layer of the multi-layered structure knitted fabric to be transported rapidly into the outer layer, serving to prevent stickiness and chill from being felt during perspiration and facilitating quick drying. Side-by-side type composite fiber filaments should preferably have a modification degree of 1.3 to 6.0. Such a modification degree of 1.3 to 6.0 will serve to increase the number of gaps to be formed among single yarns and increase the fiber density of the outer layer itself, leading to a high water-permeability. The modification degree referred to herein is defined as follows:

Modification degree=d1/d2,

where d1: the diameter of the circumscribed circle a of the fiber's cross section, and d2: the diameter of the inscribed circle β of the fiber's cross section.

The multifilament yarns (a) comprising side-by-side type composite fiber filaments should preferably account for 30 wt % or more of the yarns constituting the outer layer or the middle layer of the knitted fabric. If the percentage is less than 30 wt %, it will be difficult for sweat to be absorbed through the knitted fabric's inner layer and transported rapidly into the outer layer as described above and in addition, it will also be difficult to achieve good characteristics in terms of the average of the stretch percentages and the average of the stretch recovery percentages in the longitudinal and transverse directions. The preferred fabric forms to mix the multifilament yarns (a) into a fabric include conventional knitted union fabric with other type yarns, mixed twisted fabric, paralleled yarn fabric, covering, and combined filament yarn fabric, and an appropriate one may be selected depending on the purpose of the product, knitted fabric production method used and knitted texture.

For the water-permeability stretch knitted fabric, the average of the stretch percentages in the longitudinal and transverse directions (average stretch percentage) should preferably be 55% or more, and the average of the stretch recovery percentages in the longitudinal and transverse directions (average stretch recovery percentage) should preferably be 60% or more.

The average stretch percentage and the average stretch recovery percentage can be determined by the methods described in Examples. The stretch percentage represents the degree of stretching of the knitted fabric, and as this value increases, clothes produced from the fabric will follow the movements of the body more closely when worn and the knitted fabric will follow the quick movements during exercise more smoothly, allowing the wearer to move easily without getting much tired. The stretch recovery percentage, on the other hand, represents the degree of quick recovery of the knitted fabric stretched by the movements of the body to the original state, and as this value increases, clothes produced from the fabric will fit the body more comfortably when worn and allow the wearer to move more easily.

The stretch percentage and the stretch recovery percentage should be used in the form of the average of the values in the longitudinal and transverse directions of the knitted fabric. When worn in the form of sportswear by a wearer who actually moves, the knitted fabric will be stretched in both the longitudinal and transverse directions, rather than in only one of them, because the knitted fabric is stretched three-dimensionally to suite the curved body of the wearer. Such three dimensional stretching characteristics are in good correlation and agreement with the average stretch percentage and the average stretch recovery percentage, which represent the averages of the stretch percentages in the longitudinal and transverse direction.

From the knitted fabrics, the average of the stretch percentages in the longitudinal and transverse directions should be 55% or more, preferably 70% or more, and more preferably 80% or more. An average stretch percentage of less than 55% is not preferred because the knitted fabric will not follow the movements when worn and used for hard exercise and will make the wearer tired easily.

For the knitted fabrics, the average of the stretch recovery percentages in the longitudinal and transverse directions should be 60% or more, preferably 70% or more, and more preferably 80% or more. If the average stretch recovery percentage is less than 60%, the knitted fabric will not recover the original shape after being stretched during exercise and will not fit the body comfortably in following the movements of the body. The appearance of the cloth will also be poor.

For the water-permeability stretch knitted fabric of the invention, there are no additional specific limitations on the structure etc. if it comprises a multi-layered structure knitted fabric composed of at least two layers, i.e., the outer layer and the inner layer. For instance, it may have a multi-layered structure in which the outer layer is composed of at least two layers. In such a case, the structure may be such that the multifilament yarns (a) exist only in the middle layer and account for 30 wt % or more of it. Thus, the effect is achieved if the multifilament yarns (a) are contained in all layers or in one or more layers that constitute the multi-layered outer layer.

The appropriate knitted fabrics include circular knitted fabrics such as single jersey and double jersey; warp knitted fabrics such as single tricot, double tricot, single raschel, and double raschel, weft knitted fabrics such as single bed knit and double bed knit, and other knitted fabrics such as tights and hosiery.

There are no specific limitations on the yarns other than the multifilament yarns (a) to be used for these water-permeability stretch knitted fabrics. To produce products for sportswear, for instance, synthetic fiber multifilament yarns (b) may be used preferably to mitigate the stickiness during heavy perspiration.

To produce products for inner wear, synthetic fiber multifilament yarns (b), natural fiber, and semisynthetic fiber that are particularly high in hygroscopicity may be used particularly to mitigate the sweatiness.

There are no specific limitations on these synthetic fiber filament yarns (b), and yarns conventionally used for clothing and other materials, such as those based on polyester, polyamide, polyacrylonitrile, polypropylene, polyvinyl alcohol, or polyvinyl chloride, may be used. For further mitigation of stickiness on the skin, hydrophobic synthetic fiber filament yarns are preferred to hygroscopic synthetic fiber filament yarns.

For instance, the preferred polyester-based fibers include polyethylene terephthalate, polybutylene terephthalate, and polytrimethylene terephthalate fiber. The preferred polyamide-based fibers include, but are not limited to, nylon 6 fiber and nylon 66 fiber, and the preferred acrylic fibers include polyacrylonitrile fiber. Other preferred ones include protein fibers such as milk protein fiber and soybean protein fiber, as well as polylactic acid fiber.

These synthetic fiber multifilament yarns (b) may be drawn yarns, crimped yarns, or filament mixed yarns that are mixed with other filaments, but the preferred ones include crimped yarns and combined filament yarns based thereon. In particular, the preferred crimped yarns include false-twisted ones.

The shape of the cross section of the filaments that constitute the synthetic fiber multifilament yarns (b) may commonly circular, triangular, elliptical, or multilobar, or filaments having two or more concave grooves along the length direction may be arranged on the fiber surface. There are no specific limitations on the cross-sectional shape, and the cross section may have a shape schematically resembling a letter or symbol such as E, F, H, I, K, M, N, S, T, W, X, Y, Z, and +. However, to achieve an increase in water-permeability, it is preferable for the outer layer of the knitted fabric to contain synthetic fiber multifilament yarns (b) that comprise filaments having two or more concave portions in the fiber's length direction. There are no specific limitations on the modification degree of the filaments, but the modification degree should preferably be 6.0 or less to avoid fracture and fibrillation of the fibers that could occur to cause deterioration in the processability and quality. If synthetic fiber multifilament yarns (b) that comprise filaments having two or more concave portions in the fiber's length direction are used in the inner layer of the knitted fabric, on the other hand, the modification degree of the filaments used should preferably be lower than the modification degree of the side-by-side type composite fiber filaments in the outer layer of the knitted fabric in order to achieve a water absorption back-and-front moisture content ratio of two or more and a water absorption back-and-front diffusion area ratio of two or more, which represent a major feature. If synthetic fiber multifilament yarns (b) comprising filaments with a high modification degree are used in the inner layer of the knitted fabric, the absorbed moisture will unpreferably tend to stay in the inner layer of the knitted fabric, making it difficult to achieve a water absorption back-and-front moisture content ratio of two or more and a water absorption back-and-front diffusion area ratio of two or more, which represent a major feature.

The monofilament fineness of the filaments that constitute the synthetic fiber multifilament yarns (b) should preferably be in the range of 1.1. to 5.5 decitex. If the monofilament fineness is less than 1.1 decitex, the pilling resistance and the snag resistance will tend to deteriorate. If the monofilament fineness is more than 5.5 decitex, the texture will unpreferably become less pleasant.

There are no specific limitations on the total fineness of the synthetic fiber multifilament yarns (b), but it should preferably be in the range of 33 to 330 decitex to cover from thin to thick knitted fabrics.

The inner layer of the water-permeability stretch knitted fabric should preferably be uneven with many convex portions scattered, rather than being flat. If clothes of such a fabric with an uneven inner layer surface are worn, only the convex portions will come in point contact with the skin to mitigate stickiness during perspiration of liquid sweat, and in addition, the outer layer of the multi-layered structure knitted fabric of the invention will be higher in density while the inner layer will be lower in density to allow the liquid sweat to move efficiency by capillarity from the inner layer to the outer layer of the knitted fabric, improving the water-permeability and permeability as well as the diffusion and drying capabilities at the outer layer.

A wide range of uneven shapes including longitudinal stripes, transverse borders, grid, twill, herringbone, dots, and moss stitch may be used, and there are no specific limitations on them if they consist of concave and convex portions with height differences between them. There are no specific limitations on the methods to be used to form such concave and convex portions with height differences, and the preferred methods include the use of a specific knitted texture, the use of thin and thick yarns, and a combination of them.

With respect to the knitting conditions for the knitting process, the loop length and the runner length should preferably be longer compared with the typical knitting conditions for the common yarns to achieve a lower knitting density. This allows the side-by-side type composite fiber filaments to form crimps effectively as they are transported through the dyeing step, enabling the production of a knitted fabric having high stretchability, stretch recovery, softness, and fluffy texture.

The gray knitted fabric produced may be heat treated, scoured, or dyed by methods generally used for knitted fabrics. The side-by-side type composite fiber filaments should preferably be relaxed, degummed, and heat treated at temperatures of 80° C. or more to ensure more effective development of potential crimps. As additional treatment to this dyeing process, appropriate steps including the following may be performed: water-repellent finish, soil-resistant finish, antibacterial finish, deodorant finish, deodorizing finish, flame resistant finish, perspiretion absorptive finish, hygroscopic finish, fungus proofing finish, ultraviolet ray absorption finish, and weight reduction finish. Subsequently, post-processing steps including calendaring, embossing, washer, gigging, printing, and opal finishing may be carried out appropriately to meet the end-use requirements for characteristics.

In particular, sweat absorbent processing should preferably be performed because it serves to further improve the intended water-permeability.

By selecting appropriate materials, the water-permeability stretch knitted fabric can serve to produce a wide range of products. Such products include, for instance, fabrics for clothing such as sportswear, underwear, homewear, uniforms, and outerwear, and those for other goods including lining, shoe material, supporters, hosiery, and gloves.

The sportswear includes running shirts and trunks, athletic shirts and trunks, golf shirts, tennis shirts, cycle shirts, outdoor shirts, polo shirts, T-shirts, baseball undershirts, training wear, and sweat shirts and pants. The underwear includes general women's underwear such as slips, camisoles, petticoats, shorts, underpants, tights, T-shirts, round-neck shirts, U-neck shirts, body suits, and girdles; general men's underwear such as T-shirts, round-neck shirts, U-neck shirts, running shirts, underpants, tights, briefs, and trunks; sports underwear including modifications of the former such as wear for athletics, outdoor sports, and skiing; and underwear for workmen for outdoor and indoor work. The homewear include loungewear, pajamas, negligees, and gowns. The outerwear includes women's wear, men's wear, children's wear, and workwear. The lining products include those for sportswear, women's wear, men's wear, children's wear, ceremonial clothes, student's wear, and workwear.

### EXAMPLES

Hereinafter, our fabrics and methods are described more in detail by reference to examples, which, however, are not intended to limit the scope of this disclosure.

### Evaluation Methods

In these examples, quality evaluation was carried out by the following methods.

### Average Stretch Percentage

The stretch percentage test was carried out according to the grab method for constant rate extension specified in the JIS L 1018 “knitted fabric test method.”

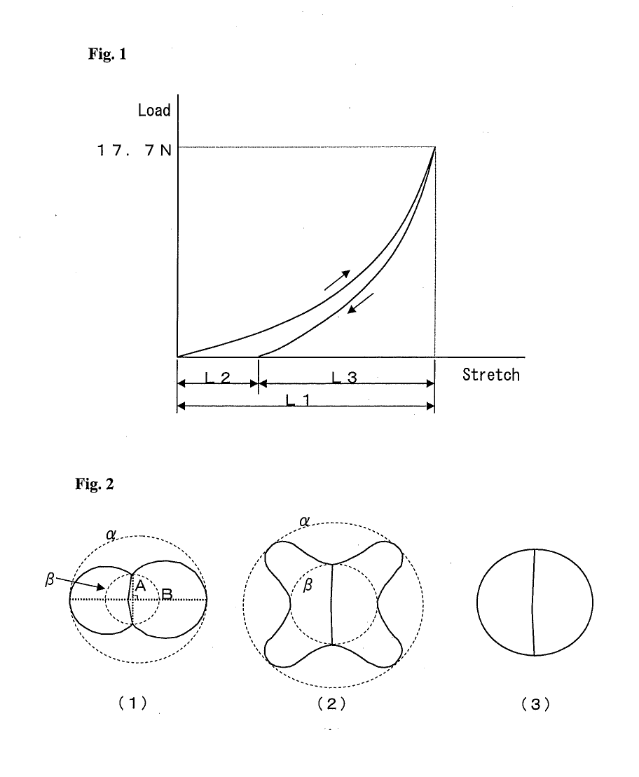

Specifically, three 10 cm×about 15 cm test pieces were taken in each of the longitudinal and transverse directions. A constant rate extension type tensile tester equipped with an autographic recorder was used, and for both upper and lower positions, a clamp of 2.54 cm×2.54 cm and a clamp of 2.54 cm×5.08 cm were used for the outer layer and the inner layer, respectively, with an interval of 7.6 cm. For each run, a test piece was fixed to the clamps after removing slackness and tension. It was extended at a tension speed 10 cm/min to reach a load of 17.7N (1.8 kg), and then the interval between the clamps was measured. Immediately after this, the clamps were moved in such a direction that the load would be removed, until the clamp interval returned to the original value of 7.6 cm. The behaviors during the loading and unloading process were recorded on an autographic recorder in the form of curves for the loading, extension and recovery periods (see FIG. 1). The stretch percentage LA (%) was determined from the curves using the following equation, and represented by the average for three test pieces:

Stretch percentage LA(%)=[(L1−L)/L]×100
L: clamp interval (mm)
L1: clamp interval (mm) at a load of 17.7N.

The stretch percentage of the knitted fabric was measured for the longitudinal and transverse directions, and the two values were summed up, followed by dividing the sum by two to determine the average stretch percentage.

### Average Stretch Recovery Percentage

To determine the stretch recovery percentage LB (%), the loading, extension and recovery curves drawn on the autographic recorder were analyzed, and the residual strain L2 (mm) was determined from the point where the recovery curve reached a load of zero. Then, the stretch recovery percentage LB (%) was calculated from the following equation, and represented by the average for three test pieces:

Stretch percentage recovery percentage LB(%)=(L3/L1)×100
L3: (clamp interval <L1>-residual strain <L2>) at a load of 17.7N.

The stretch recovery percentage of the knitted fabric was measured for the longitudinal and transverse directions, and the two values were summed up, followed by dividing the sum by two to determine the average stretch recovery percentage.

### Water Absorption Back-and-Front Moisture Content Ratio

On a glass plate, 1.0 cc of distilled water was dropped, and a 10 cm×10 cm test piece of the knitted fabric was put on it with the inner surface down so that the inner surface would come in contact with the distilled water. The test piece of the knitted fabric was left to stand for 60 seconds, and transferred onto another glass plate, which was then sandwiched between two pieces of filter paper cut into the same size and left to stand for 60 seconds under a load of 5 g/m². Subsequently, the weight of water retained in the knitted fabric was determined from the difference between the weight of the knitted fabric after absorbing water and the original weight of the knitted fabric, and the water retention percentages of the outer and inner surfaces of the knitted fabric were determined from the weight of water absorbed by the two pieces of filter paper in contact with the outer and inner surfaces. Measurements were made for three test pieces of the knitted fabric. The ratio of water retention percentage (water retention percentage of outer layer/water retention percentage of inner layer) was calculated from these measurements.

The value of the ratio of water retention percentage represents the state of the absorbed water. Thus, if the outer layer has a large water retention percentage and a large rate of water retention percentage, it means that the distilled water is transported efficiently into the outer layer, indicating that the knitted fabric is high in permeability and feels less sticky when worn.

### Water Absorption Back-and-Front Diffusion Area Ratio

On a glass plate, 0.1 cc of an ink solution prepared by diluting a commercial ink product twice was dropped, and a test piece of the knitted fabric was put on it with the inner surface down so that the inner surface would come in contact with the ink solution. It was left to stand for 60 seconds to allow the ink solution to be absorbed, and then transferred onto another glass plate, where it was left to stand again with the inner surface down for 3 minutes. The same test run was carried out for three test pieces of the knitted fabric. The diffusion area of the ink solution in the outer and inner surfaces of the knitted fabric test pieces thus obtained was measured, and the area ratio (diffusion area in outer layer/diffusion area in inner layer) was calculated from the measurements.

The value of the diffusion area represents the state of the absorbed ink solution. Thus, if the outer layer has a large diffusion area and a large area ratio, it means that the ink solution is transported efficiently into the outer layer, indicating that the knitted fabric has high water absorption, permeation and diffusion capabilities.

The fact that the outer layer has a large diffusion area also indicates that the knitted fabric can come in contact with the air efficiently and therefore dry quickly.

Both the water absorption back-and-front moisture content ratio and the water absorption back-and-front diffusion area ratio should preferably be two or more, but the two ratios do not necessarily have the same value. The value of the water absorption back-and-front moisture content ratio is a key factor in decreasing the stickiness on the skin. On the other hand, the value of the water absorption back-and-front diffusion area ratio has a larger influence on whether the knitted fabric can dry quickly.

### Evaluation of Wearing Comfortability of the Water-Permeability Stretch Knitted Fabric

T-shirts that fit the body comfortably were produced from the knitted fabric, and five test subjects who wore the T-shirts jogged on a treadmill at 12 km/hour for 10 minutes in a room adjusted to 25° C. and 65% RH. Subsequently, the easiness of movement and stickiness during perspiration were determined based on their self-assessment information and the T-shirts were classified into three groups:
Excellent: able to move very easily, not sticky at all
Good: able to move as easily as in a common product, not significantly sticky
Inferior: not able to move easily, significantly sticky.

### Overall Performance Evaluation

The total points were calculated according to the criterion shown in Table 1, and the overall performance was evaluated as follows:
15 points or more: excellent (good as water-permeability stretch knitted fabric)
10 to 14 points: good (not satisfactory as water-permeability stretch knitted fabric)
9 points or less: inferior (inferior as water-permeability stretch knitted fabric).

### Example 1

A homo PTT sample with an intrinsic viscosity (IV) of 1.40 and a melt viscosity at 275° C. of 750 poise and a homo PET sample with an intrinsic viscosity (IV) of 0.60 and a melt viscosity at 275° C. of 650 poise were melted separately, and discharged together at a spinning temperature of 275° C. and a composition ratio of 50:50 (by wt %) through a composite-shape 48-hole spinning orifice designed to produce a yarn with a daruma-type cross section as shown in FIG. 2(1), and taken up at a spinning velocity of 1400 m/min to produce a side-by-side type composite unstretched yarn. The yarn was stretched by a drawing machine consisting of a hot roll and hot plate and then, without being taken up, directly relaxed and wound up to produce a 110-decitex multifilament yarn consisting of 48 filaments that were not in the same coil phase. The resulting multifilament yarn had a cross section of a snowman-like shape.

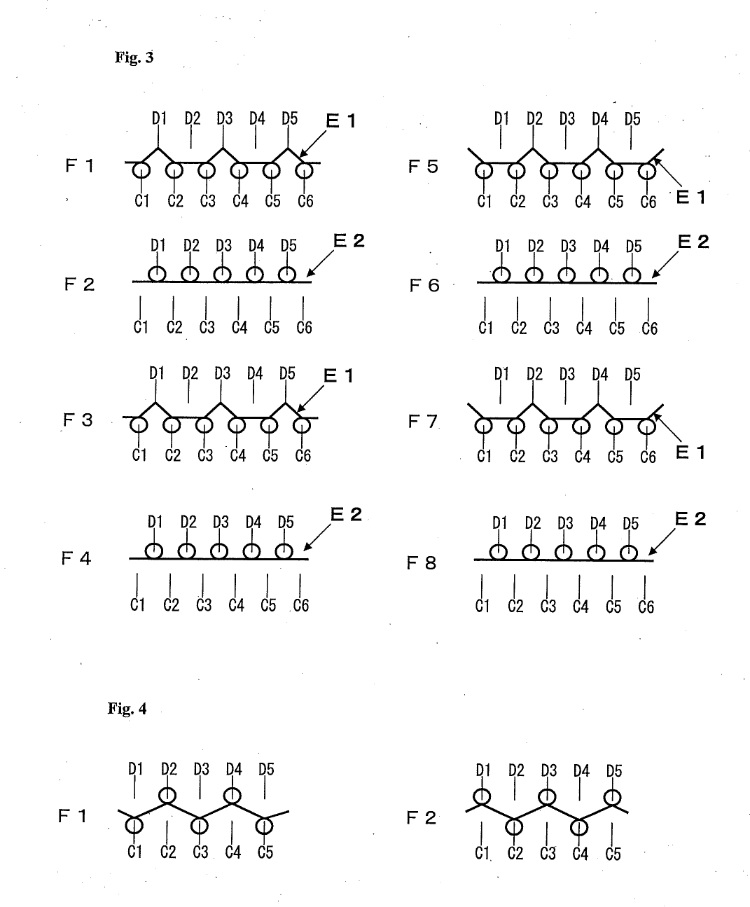

A 22G interlock circular knitting machine was sued to produce a reversible knitted fabric (gray fabric) consisting of a flat outer layer of 100% multifilament yarns (snowman-like shape cross section) and a meshed inner layer of 100% polyester-filament textured yarns by using a multifilament yarn (110 decitex, 48 filaments) composed of the aforementioned PTT/PET side-by-side composite fiber filaments as the component yarn E2 shown in the knitting diagram in FIG. 3 and using a 84-decitex, 36-filament, polyester textured yarn (Tetron supplied by Toray Industries, Inc.) as the component yarn E1.

This gray fabric was relaxed, scoured, dyed, and finished according to a dyeing method commonly used for circular knitted polyester fabrics to produce a knitted fabric with a metsuke (mass per unit area) of 179 g/m². The resulting knitted fabric had high water-permeability and stretchability with a water absorption back-and-front moisture content ratio of 4.0, water absorption back-and-front diffusion area ratio of 4.3, average stretch percentage for longitudinal and transverse directions of 79%, and average stretch recovery percentage of 85%. Furthermore, the outer layer of the knitted fabric was free of crimps.

According to wearing comfortability evaluation, the knitted fabric enabled easy movements during exercise and eliminated stickiness during perspiration, indicating that it was a water-permeability stretch knitted fabric with excellent quality as a whole. Results are shown in Table 1.

### Example 2

Polymer samples similar to those used in Example 1 were discharged together at a composition ratio of 50:50 (by wt %) through a composite-shape 36-hole spinning orifice designed to produce a yarn with an X-type cross section as shown in FIG. 2(2), and then subjected to the same steps as in Example 1 to produce a 84-decitex multifilament yarn consisting of 36 filaments that were not in the same coil phase.

Except that this yarn was used as the component yarn E2 in the knitting diagram shown in FIG. 3, the same procedure as in Example 1 was carried out for knitting and dyeing to produce a knitted fabric with a metsuke (mass per unit area) of 162 g/m² consisting of a flat outer layer of 100% multifilament yarns (X-shape cross section) composed of the PTT/PET side-by-side composite fiber filaments and a meshed inner layer of 100% polyester-filament textured yarns. The resulting knitted fabric had high water-permeability and stretchability with a water absorption back-and-front moisture content ratio of 5.4, water absorption back-and-front diffusion area ratio of 9.5, average stretch percentage for longitudinal and transverse directions of 72%, and average stretch recovery percentage of 89%. Furthermore, the outer layer of the knitted fabric was free of crimps.

According to wearing comfortability evaluation, the knitted fabric enabled easy movements during exercise and eliminated stickiness during perspiration, indicating that it was a water-permeability stretch knitted fabric with excellent quality as a whole. Results are shown in Table 1.

### Example 3

A multifilament yarn (110 decitex, 48 filaments) composed of the PTT/PET side-by-side composite fiber filaments and a 84-decitex, 36-filament, polyester textured yarn (Tetron supplied by Toray Industries, Inc.), which were the same as those described in Example 1, were used alternately as the component yarn E2 in the knitting diagram shown in FIG. 3 while the 84-decitex, 36-filament, polyester textured yarn (Tetron supplied by Toray Industries, Inc.) was used as the component yarn E1 to produce a reversible knitted fabric (gray fabric) consisting of a flat outer layer of 52% multifilament yarns (snowman-like shape cross section) and a meshed inner layer of 100% polyester-filament textured yarns.

This gray fabric was relaxed, scoured, dyed, and finished according to a dyeing method commonly used for circular knitted polyester fabrics to produce a knitted fabric of 170 g/m². The resulting knitted fabric had high water-permeability and stretchability with a water absorption back-and-front moisture content ratio of 3.2, water absorption back-and-front diffusion area ratio of 3.9, average stretch percentage for longitudinal and transverse directions of 70%, and average stretch recovery percentage of 91%. Furthermore, the outer layer of the knitted fabric was free of crimps.

According to wearing comfortability evaluation, the knitted fabric enabled easy movements during exercise and eliminated stickiness during perspiration, indicating that it was a water-permeability stretch knitted fabric with excellent quality as a whole. Results are shown in Table 1.

### Comparative Example 1

Polymer samples similar to those used in Example 1 were discharged together at a composition ratio of 50:50 (by wt %) through a composite-shape 36-hole spinning orifice designed to produce a yarn with an circular cross section as shown in FIG. 2(3), and then subjected to the same steps as in Example 1 to produce a 84-decitex multifilament yarn consisting of 36 filaments.

Except that this yarn was used as the component yarn E2 in the knitting diagram shown in FIG. 3, the same procedure as in Example 1 was carried out for knitting and dyeing to produce a knitted fabric with a metsuke (mass per unit area) of 165 g/m² consisting of a flat outer layer of 100% multifilament yarns (circular cross section) composed of the PTT/PET side-by-side composite fiber filaments and a meshed inner layer of 100% polyester-filament textured yarns. With a water absorption back-and-front moisture content ratio of 1.3, water absorption back-and-front diffusion area ratio of 1.9, average stretch percentage for longitudinal and trans-verse directions of 78%, and average stretch recovery percentage of 87%, the resulting knitted fabric failed to have satisfactory water-permeability though having high stretchability. According to wearing comfortability evaluation, the knitted fabric enabled easy movements during exercise, but had significant stickiness during perspiration, indicating that it was not a water-permeability stretch knitted fabric with satisfactory quality as a whole. Results are shown in Table 1.

### Comparative Example 2

Except that in a 28G interlock circular knitting machine, the same multifilament yarns (circular cross section) of PTT/PET side-by-side composite fiber filaments as described in Comparative Example 1 were used for all yarn feeding ports in the knitting diagram shown in FIG. 4, the same procedure for dyeing as in Example 1 was carried out to produce a knitted fabric with a metsuke (mass per unit area) of 195 g/m². With a water absorption back-and-front moisture content ratio of 0.8, water absorption back-and-front diffusion area ratio of 1.0, average stretch percentage for longitudinal and transverse directions of 81%, and average stretch recovery percentage of 89%, the resulting knitted fabric had only poor water-permeability though having high stretchability. According to wearing comfortability evaluation, the knitted fabric enabled easy movements during exercise, but had strong stickiness during perspiration, indicating that it was not a water-permeability stretch knitted fabric with satisfactory quality as a whole. Results are shown in Table 1.

### Comparative Example 3

A multifilament yarn (110 decitex, 48 filaments) composed of the PTT/PET side-by-side composite fiber filaments and a 84-decitex, 36-filament, polyester textured yarn (Tetron supplied by Toray Industries, Inc.), which were the same as those described in Example 1, were used in the ratio 1:3 as the component yarn E2 in the knitting diagram shown in FIG. 3 while the 84-decitex, 36-filament, polyester textured yarn (Tetron supplied by Toray Industries, Inc.) was used as the component yarn E1 to produce a reversible knitted fabric (gray fabric) consisting of a flat outer layer of 28% multifilament yarns (snowman-like shape cross section) composed of PTT/PET side-by-side composite fiber filaments and a meshed inner layer of 100% polyester-filament textured yarns.

This gray fabric was relaxed, scoured, dyed, and finished according to a dyeing method commonly used for circular knitted polyester fabrics to produce a knitted fabric of 169 g/m². With a water absorption back-and-front moisture content ratio of 1.8, water absorption back-and-front diffusion area ratio of 2.1, average stretch percentage for longitudinal and transverse directions of 53%, and average stretch recovery percentage of 55%, the resulting knitted fabric had high water-permeability, but with slightly poor stretchability. According to wearing comfortability evaluation, the knitted fabric hindered smooth movements during exercise, though being free of stickiness during perspiration, indicating that it was not a water-permeability stretch knitted fabric with satisfactory quality as a whole. Results are shown in Table 1.

TABLE 1

| | back-and- | back-and- | average | average | wearing comfortability | |
|---|---|---|---|---|---|---|
| | front | front | stretch | stretch | test results | |
| | moisture | diffusion | percentage | recovery | easiness of | |
| points | content ratio | area ratio | (%) | percentage (%) | movement | stickiness |
| 3 | 4.0 or more | 4.0 or more | 75 or more | 80 or more | excellent | excellent |
| 2 | 2.0 or more | 2.0 or more | 55 or more | 60 or more | good | good |
| | less than 4.0 | less than 4.0 | less than 75 | less than 80 | | |
| 1 | less than 2.0 | less than 2.0 | less than 55 | less than 60 | inferior | inferior |

Table 1 shows the points allotted to each of the evaluation items used for the overall quality evaluation.

TABLE 2

| | | | | back-and- | back-and- | average | average | wearing comfortability | | |
|---|---|---|---|---|---|---|---|---|---|---|
| | | | | front | front | stretch | stretch | test results | | |
| | | | Surface | moisture | diffusion | percentage | recovery | easiness of | | overall |
| | structure | Type of yarn | mix ratio | content ratio | area ratio | (%) | percentage (%) | movement | stickiness | evaluation |
| Example 1 | outer: flat | 110T-48F | 100 | 4.0 | 4.3 | 79 | 85 | excellent | excellent | excellent |
| | | (PTT/PET: | | | | | | | | |
| | | snowman- | | | | | | | | |
| | | like shape) | | | | | | | | |
| | inner: mesh | 84T-36F | — | | | | | | | |
| | | (PET textured | | | | | | | | |
| | | yarn) | | | | | | | | |
| Example 2 | outer: flat | 84T-36F | 100 | 5.4 | 9.5 | 72 | 89 | excellent | excellent | excellent |
| | | (PTT/PET: | | | | | | | | |
| | | X-SHAPE) | | | | | | | | |
| | inner: mesh | 84T-36F | — | | | | | | | |
| | | (PET textured | | | | | | | | |
| | | yarn) | | | | | | | | |
| Example 3 | outer: flat | 110T-48F | 52 | 3.2 | 3.9 | 70 | 91 | good | good | good |
| | (1 × 1) | (PTT/PET: | | | | | | | | |
| | | snowman- | | | | | | | | |
| | | like shape) | | | | | | | | |
| | | 84T-36F | 48 | | | | | | | |
| | | (PET textured | | | | | | | | |
| | | yarn) | | | | | | | | |
| | inner: mesh | 84T-36F | — | | | | | | | |
| | | (PET textured | | | | | | | | |
| | | yarn) | | | | | | | | |
| Comparative | outer: flat | 84T-36F | 100 | 1.3 | 1.9 | 78 | 87 | excellent | inferior | inferior |
| Example 1 | | (PTT/PET: | | | | | | | | |
| | | circular) | | | | | | | | |
| | inner: mesh | 84T-36F | — | | | | | | | |
| | | (PET textured | | | | | | | | |
| | | yarn) | | | | | | | | |
| Comparative | outer, inner: | 84T-36F | 100 | 0.8 | 1.0 | 81 | 89 | excellent | inferior | inferior |
| Example 2 | flat | (PTT/PET: | | | | | | | | |
| | | circular) | | | | | | | | |
| Comparative | outer: flat | 110T-48F | 28 | 1.8 | 2.1 | 53 | 55 | inferior | good | inferior |
| Example 3 | (1 × 3) | (PTT/PET: | | | | | | | | |
| | | snowman- | | | | | | | | |
| | | like shape) | | | | | | | | |
| | | 84T-36F | 72 | | | | | | | |
| | | (PET textured | | | | | | | | |
| | | yarn) | | | | | | | | |
| | inner: mesh | 84T-36F | — | | | | | | | |
| | | (PET textured | | | | | | | | |
| | | yarn) | | | | | | | | |

T: decitex,
F: number of filaments
PTT/PET: side-by-side type composite yarn composed of polytrimethylene terephthalate and polyester,
PET: polyester

Table 2 shows features of the test pieces produced in Examples 1 to 3 and Comparative Examples 1 to 3 and results of evaluation.

### INDUSTRIAL APPLICABILITY

We provide water-permeability stretch knitted fabrics over a wide thickness range from thin to thick that have sufficiently high sweat removing performance and stretchability and serve to produce sportswear, innerwear, lining, and other materials used in various fields.

1. A water-permeability stretch knitted fabric of a multi-layered structure, comprising at least an outer layer and an inner layer, wherein 30 wt % or more of said outer layer is accounted for by multifilament yarns (a) that comprise composite fiber filaments composed of two types of polyester polymer materials adhered to each other side by side in a length direction of the fiber, the water-permeability of the knitted fabric being such that both the water absorption back-and-front moisture content ratio and the water absorption back-and-front diffusion area ratio between the outer layer and the inner layer are two or more, and the average for the stretch percentages and that for the stretch recovery percentages in the longitudinal and transverse directions of the knitted fabric being 55% or more and 60% or more, respectively.

2. The water-permeability stretch knitted fabric as claimed in claim 1, wherein at least one of said two types of polyester polymer materials comprises polytrimethylene terephthalate.

3. The water-permeability stretch knitted fabric as claimed in claim 1, wherein a cross section of the composite fiber filament yarns composed of two types of polyester polymer materials adhered side by side to each other in the fiber's length direction has at least one concave portion with a modification degree of 1.3 to 6.0.

4. The water-permeability stretch knitted fabric as claimed in claim 2, wherein a cross section of the composite fiber filament yarns composed of two types of polyester polymer materials adhered side by side to each other in the fiber's length direction has at least one concave portion with a modification degree of 1.3 to 6.0.

5. The water-permeability stretch knitted fabric as claimed in claim 3, wherein the cross section of said composite fiber filaments has a snowman-like shape.

6. The water-permeability stretch knitted fabric as claimed in claim 4, wherein the cross section of said composite fiber filaments has a snowman-like shape.

7. The water-permeability stretch knitted fabric as claimed in claim 1, wherein monofilament fineness of said composite fiber filaments is 0.1 to 11 decitex and total fineness for the multifilament yarns (a) is 22 to 330 decitex.

8. The water-permeability stretch knitted fabric as claimed in claim 2, wherein monofilament fineness of said composite fiber filaments is 0.1 to 11 decitex and total fineness for the multifilament yarns (a) is 22 to 330 decitex.

9. The water-permeability stretch knitted fabric as claimed in claim 1, wherein said outer layer has a multi-layered structure composed of at least two layers.

10. The water-permeability stretch knitted fabric as claimed in claim 2, wherein said outer layer has a multi-layered structure composed of at least two layers.
